(19) United States
(12) Patent Application Publication
(10) Pub. No.: US 2018/0253201 A1
(43) Pub. Date: Sep. 6, 2018

(54) SYSTEMS AND METHODS FOR A MULTI-DISPLAY COLLABORATION ENVIRONMENT

(71) Applicant: Wal-Mart Stores, Inc., Bentonville, AR (US)

(72) Inventors: Donald High, Noel, MO (US); Henry Sampara, Bentonville, AR (US)

(73) Assignee: Wal-Mart Stores, Inc., Bentonville, AR (US)

(21) Appl. No.: 15/561,422

(22) PCT Filed: Mar. 24, 2016
(86) PCT No.: PCT/US2016/023993

§ 371 Date: Sep. 25, 2017

Related U.S. Application Data
(60) Provisional application No. 62/138,699, filed on Mar. 26, 2015.

(51) Int. Cl. G06F 3/0484; G06Q 10/10; G06F 3/0481; H04N 7/15

(52) U.S. Cl. CPC G06F 3/0484; H04N 7/15; G06F 3/0481; G06Q 10/101

(57) ABSTRACT

Systems, methods, and machine readable medium are provided for configuring a graphical user interface in a remote collaboration environment. Representation of a digital meeting room is provided including a plurality of representations of interactive displays, where each of the plurality of representations of the interactive displays is configured to render a graphical representation of analyzed data. A first user interface is rendered on a first mobile device and a second user interface is rendered on a second mobile device, where each of the first and second user interfaces represent the digital meeting room. Input is received at the first user interface indicating an interaction with one of the interactive displays, where the user interaction causes modification of one of the rendered representations of the analyzed data. At least one of the representations of the interactive displays of the second user interface is updated to display the modified graphical representations.

### RELATED APPLICATION

This application claims priority to U.S. Provisional Patent Application No. 62/138,699 entitled “Systems and Methods for a Multi-Display Collaboration Environment,” filed on Mar. 26, 2015, which is hereby incorporated by reference in its entirety.

### BACKGROUND

People are often prevented from attending meetings due their busy schedules. The individuals needed at a meeting may be located in various geographic areas. The conventional video conferencing systems allow users to at least listen to an ongoing meeting and view a meeting slide or video presentation. However, users of these conventional systems are limited in their ability to actively participate in the meeting. Many conventional systems are also limited to merely sharing a user's desktop.

### BRIEF DESCRIPTION OF THE DRAWINGS

The foregoing and other features and advantages provided by the present disclosure will be more fully understood from the following description of exemplary embodiments when read together with the accompanying drawings, in which:

FIG. 1 depicts a system for a multi-display collaboration environment, according to example embodiments;

FIG. 2 is a flowchart illustrating an exemplary method for configuring a graphical user interface in a multi-display collaboration environment, according to example embodiments;

FIG. 3 is diagram illustrating an example system in a multi-display collaboration environment, according to example embodiments;

FIG. 4 is an exemplary graphical user interface rendered on a mobile device in a multi-display collaboration environment, according to example embodiments;

FIG. 5 is a diagram of an exemplary network environment suitable for a distributed implementation of exemplary embodiments; and

FIG. 6 is a block diagram of an exemplary computing device that may be used to implement exemplary embodiments of the multi-display collaboration environment described herein.

### DETAILED DESCRIPTION

Systems, methods, and computer readable mediums are described for a multi-display collaboration environment. Example embodiments provide for configuring a graphical user interface in a collaboration environment. Some conventional video conferencing systems merely allow for a user to share his desktop or screen. Other conventional systems merely allow a user to show a presentation slide deck. Also, these conventional systems limits other users' ability to actively participate in a meeting. The multi-display collaboration environment described herein allows a user to display multiple screens at a time in a meeting user interface, and allows are a user to actively interact with the data displayed in the multiple screens in the user interface for the meeting. A user can also participate in the meeting remotely via his mobile device. In many instances, where the mobile device has a touch-screen interface, the user can also interact with the multiple screens using the touch-screen interface. Additionally, in some embodiments, the multiple screens for the meeting are also provided in a physical meeting room for other users to attend the meeting from a physical room. Each of the screens displayed in the meeting user interface is an interactive display including a graphical representation or visualization of data. Each of the multiple interactive displays can contain different visualizations of a data set. In some embodiments, the visualization of data included in the multiple interactive displays is a statistical analysis model of a large volume of data. A user can interact with the visualization of the data via his device. When a user interacts with a display, the corresponding display for the other users participating in the meeting is updated to reflect the interaction. In this way, users can actively collaborate and analyze multiple topics at the same time.

The following description is presented to enable any person skilled in the art to create and use a computer system configuration and related method and systems to configure a graphical user interface in a remote collaboration environment. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

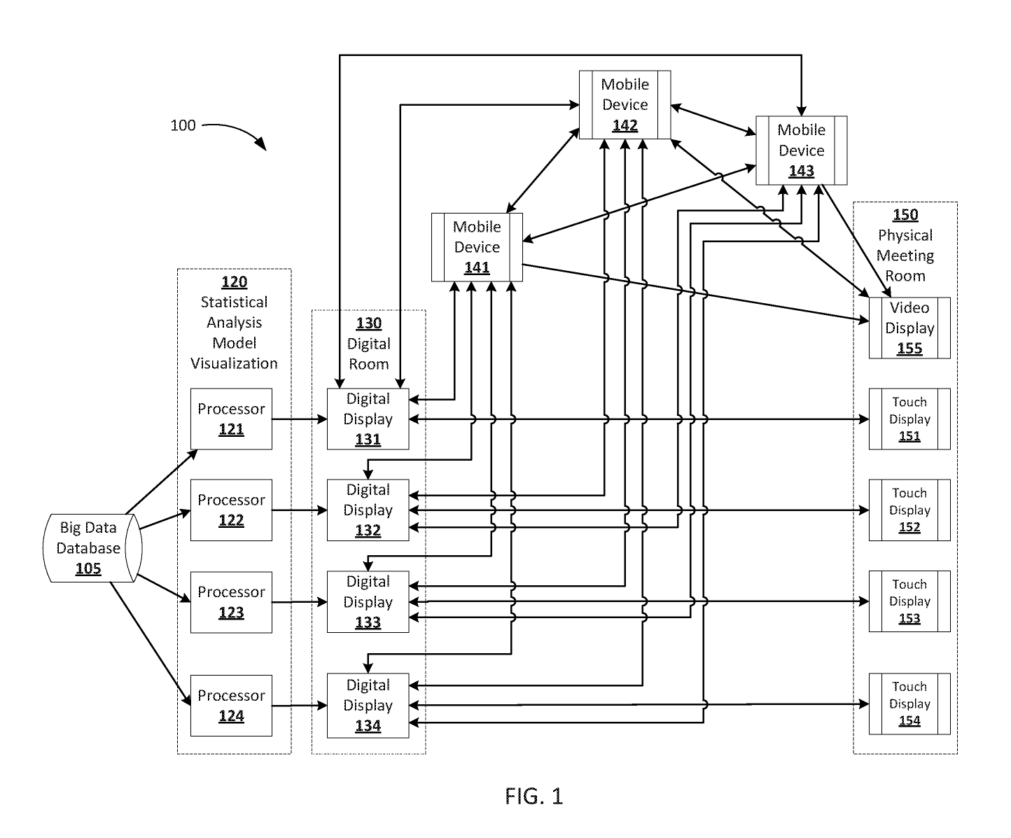

FIG. 1 depicts a system 100 for a multi-display collaboration environment, according to an example embodiment. The system 100 includes a database 105, multiple processors, such as processor 121, processor 122, processor 123, and processor 124, multiple digital displays, such as digital display 131, digital display 132, digital display 133, and digital display 134, multiple mobile devices, such as mobile device 141, mobile device 142, and mobile device 143, a video display device 155, and multiple touch display devices, such as touch display device 151, touch display device 152, touch display device 153, and touch display device 154. The multiple processors 121, 122, 123, and 124, may form the statistical analysis model visualization component 120. The multiple digital displays 131, 132, 133, and 134 may form the digital room 130. The video display device 155, and the multiple touch display devices 151, 152, 153, and 154 may form the physical meeting room 150.

The various components of system 100 may be in communication, wirelessly or wired, with one or more other components of system 100. For example, the database 105 is in communication with the processors 121-124, the processors 121-124 are in communication with the digital displays 131-134. The digital displays 131-134 are in communication with the mobile devices 141-143 and touch display devices 151-154. The mobile devices 141-143 are in communication with the video display device 155. The interactions and communications between the various components of the system 100 are described in detail below.

The database 105 may be a big data database, containing a large volume of both structured and unstructured data. In some embodiments, database 105 may consist of multiple databases storing large amounts of data. In some embodiments, the data stored in database 105 may be related to information used by a retail store chain to facilitate and manage the sales process and the distribution process of various products. In this embodiment, the database 105 contains data related to customer information, product information, time series information, store location information, and the like. The database 105 may also contain other business related data or business intelligence data. In some embodiments, the data in database 105 is provided in real-time or updated to be real-time data. For example, the data in database 105 may include current sales number and information for a product, which is updated as sales occur across a number of stores part of the retail store chain.

The processors 121-124 in the statistical analysis model visualization component 120 facilitate data processing and visualization of data on digital displays 131-134. The processors 121-124 are configured to process and analyze data from the database 105 to provide, in some embodiments, a statistical analysis model. The processors 121-124 contain software code and instructions to generate a statistical analysis model from the data stored in database 105. Once a statistical analysis model is generated, the processors 121-124 facilitate visualization of the model. For example, the processors 121-124 may identify the best means of presenting the statistical analysis model. In some cases, the model may be best presented in a graph or chart form. In other cases, the model may be best presented in a table format or a map format. The processors 121-124 provide the model visualization to the digital displays 131-134 for display. Each of digital displays 131, 132, 133, and 134 is in communication with one of processors 121, 122, 123, and 124. In an example embodiment, the statistical analysis model rendered on a first interactive display corresponds to a larger data set than the statistical analysis model rendered on a second interactive display.

In an example embodiment, a pair of processor and digital display, for example processor 121 and digital display 131, may be configured to process, analyze and display data related to a specific topic or event, such as product sales. While another pair of processor and digital display, for example, processor 122 and digital display 132, may be configured to process, analyze, and display data related to customer information. In an alternative embodiment, a pair of processor and digital display, for example processor 121 and digital display 131, may be configured to process, analyze, and display data for a specific visualization, such as a map format for product sales. While another pair of processor and digital display, for example processor 122 and digital display 132, may be configured to process, analyze, and display the same data in a table format. In this manner, in some embodiments, the multiple digital displays 131-134 provide visualization of different sets of data related to one or more topics or events. In other embodiments, the multiple digital displays 131-134 provide visualization of data related to one topic or event in different formats.

In some embodiments, the multi-display collaboration environment is capable of providing the retail store business information related to who (for example, customer, customer type, customer demographics, customer location, etc.), what (for example, inventory data, merchandise hierarchy, sell price, etc.), where (for example, location of store, description of store, specials at store, etc.), when (for example, regional events such as superbowl, holiday dates, calendar information, fiscal year information, etc.), how (for example, transaction information, type of register used, online purchases, etc.), and why (for example, external factors such as weather, stock information, market share, market size, etc.). To visualize data relating to these categories, a user can choose from a number of predetermined visualizations. For example, to visualize why an event occurred, the user can choose to display, on one of the digital displays, a weather analyzer visualization. To visualize what product was affected, the user can choose to display a merchandise analyzer visualization on another screen. To visualize how much of the product was affected, a user can choose to display a marketshare analyzer visualization one another screen. In this manner, the multi-display collaboration environment is capable of providing a comprehensive view of data related to a specific topic or event, and users participating in the meeting are able to make efficient and informed decisions.

Other visualizations include a geo-spatial operations analyzer (for analyzing where an event's effect were experienced), a time series analyzer (for analyzing when the event's effects were experienced), a member analyzer (for analyzing who was affected by the event), and a real-time event analyzer (analyzing features of the event in real-time). These visualizations can be selected for various levels of the business, such as, a global level, a regional level, and a state level. A user can also drill-down into a visualization to view data related to a general merchandize manager (GMM) level, a divisional merchandize manager (DMM) level, category, and sub-category. The processors 121-124 are programmed to generate these pre-determined visualizations based on the data stored in database 105. In some embodiments, a user can program the processor to generate a customized visualization, other than the pre-determined visualization. The processors 121-124 may use traditional statistical analysis tools and models to generate the visualizations.

Due to the volume of data to be processed and that the each digital display 131, 132, 133, 134 may display a different statistical analysis model, each of digital display 131, 132, 133, 134, is coupled to one processor, forming a pair of processor and digital display. Providing a digital display its own processor also facilitates processing of real-time data. In some embodiments, a digital display may be coupled to more than one processor, while one processor may be coupled to more than one digital display. In some embodiments, the statistical analysis model visualization component 120 may include more processors and other components to facilitate and manage data processing.

In an example embodiment, at least one of the multiple interactive displays may include a plurality of interactive task representations, and where at least one of the plurality of interactive task representations corresponds to the statistical analysis model of one of the plurality of interactive displays. In another embodiment, the multi-display collaboration environment can be used as digital scrum board to facilitate and manage software development projects. The multiple screens may include a plurality of interactive user interface elements representing one or more tasks in a software development project. As a non-limiting example, at least one of the interactive user interface elements can be displayed as a simulated sticky note. Each of the plurality of interactive user interface elements may be associated with one or more blocks of source code stored in one or more databases (such as database 105), and associated with one or more blocks of object code stored in one or more object code databases. Each of the blocks of object code may be compiled from a corresponding block of source code.

In operation, for example, a user can relocate one or more of the user interface elements corresponding to a source or object code within the user interface by dragging it from one of the multiple screens to another. A user can migrate code between object code and source code by dragging the corresponding user interface element. A user can also move a block of code between various phases of the development project, such as, development phase, test phase, quality assurance phase, and production phase. Dragging and moving a user interface element (such as but not limited to a sticky note) automatically updates the status of the code to the corresponding phase of the project. In this embodiment, the multi-display system is thus configured to migrate the code between source and object code databases associated with updated task status, advantageously preventing inconsistency between a scrum board and actual task status, and further allowing the user of the digital scrum board to exert actual, real-time control over task and associated code status.

Referring to the example embodiment of a digital scrum board, processors 121-124 may be configured to recognize migration of blocks of object code into or out of a corresponding object code database. Upon recognizing of migration, each of processors 121-124 automatically executes the blocks of object code stored in the corresponding object code databases. Also the processors 121-124 are configured to execute the blocks of object code upon receiving a user or machine command (for example, via any one of the mobile devices 141-143, or touch-display devices 151-154). Execution of the blocks of object code may require a quantity of data for processing by the object code during execution. In some embodiments, a user-designed data set may be provided for processing by the object code during execution. In some embodiments, database 105 may provide a data set for processing by the object code during execution. In some embodiments, a full-scale, historical data set is provided for processing by the object code during execution. In some embodiments, a full-scale, real-time data set is provided for processing by the object code during execution.

In the digital scrum board embodiment, the digital displays 131-134 may be configured to display a representation of the executed object code. The representation of the executed object code can include, for example, charts, graphs, maps, pictures, videos, and/or any other suitable representation. As described herein, a representation of each of the digital displays 131-134 is rendered in a user interface on the mobile device 141-143. The representations of the digital displays 131-134 on mobile devices 141-143 can be configured to be interactive so that a user can query the displayed results and/or further constrain inputs used during execution of the object code, and/or interact with the representation of the executed object code. For example, processor 121-124 may execute a block of data analysis object code stored to analyze a large quantity of the full-scale, real-time data and instruct one of the digital displays 131-134 to display the representation of the executed object code. During review of the results on the mobile devices 141-143, a user may choose to focus only on a portion of the large quantity of data, in which case the user can interact with the representation of one of the digital displays 131-134 on his mobile device 141-143 to provide input indicating a user interaction of filtering the data accordingly and re-executing the object code. For example, if the user wanted to focus on a particular aspect of the data, such as, only portions relating to a geographical region or location, only portions relating to sales of a particular product, or only portions relating to supply chain metrics, etc., the user can input those restrictions via his mobile device 141-143, thereby causing the processors 121-124 to filter the data accordingly and re-execute the object code with the filtered data set. The processors 121-124 then instruct the digital displays 131-134 to display the updated representation of the executed code, and the representations of the digital displays 131-134 are also updated in the user interfaces on mobile devices 141-143 and the touch-display devices 151-154 in the physical meeting room 150. Thus, a user can interact with the multiple interactive screens displayed in the user interface on his mobile device, and cause a modification of the graphical representation of data in the multiple interactive screens. This modification is reflected in the user interfaces of other mobile devices participating in the meeting, and on the devices in the physical meeting room.

The digital room 130 may be a virtual room provided in one or more servers. The digital displays 131-134 may be virtual displays grouped together to form the digital room 130. The digital room 130 may include more than four digital displays. A multi-display collaboration environment may contain more than one instance of a digital room to support multiple collaborations or meetings simultaneously. The digital display 131-134 are interactive displays, that is a user can interact with the display. In one embodiment, a user can interact and manipulate the data displayed on the digital display 131, 132, 133, or 134 via his mobile device 141, 142, or 143. For example, the user can zoom-in on a data point on a map, or drill down to a value on a chart. An input can be received via the mobile device 141, 142, and 143 indicating a user interaction with the representation of the digital display in the user interface on the mobile device 141, 142, and 143. User can enter the input via a touch-screen interface on the mobile device 141, 142, and 143. In alternative embodiments, the user can enter the input via a pointing device (for example, a mouse) or a keyboard in communication with the mobile device 141, 142, and 143.

The physical meeting room may be a physical room consisting of multiple touch display devices 151-154, such as, a monitor with a touch-screen display to receive input from a user. Each of touch display devices 151-154 may be coupled to a computer, such as, a desktop computer, a laptop, a multi-processor system, and the like. In some embodiments, the display devices 151-154 may not include a touch-interface to receive input. The physical meeting room also includes a video display device 155 that provides a video stream from the mobile devices 141-143 participating in the multi-collaboration environment. In some embodiments, the video display device 155 may display images for the users instead of a video stream. The physical room 150 may include more than one video display device 155. The video display device 155 may be any display device capable of displaying video data or image data, such as a computer or a television. The multiple touch display devices 151-154 are also updated to reflect any user interaction with the graphical representation of data rendered on the digital display. In this manner, the multi-display collaboration environment allows remote users to participate in a meeting via their mobile devices, along with users in a physical meeting room.

The mobile devices 141-143 may be devices used by a user to participate in a multi-display collaboration environment. The mobile devices 141-143 may comprise, but are not limited to, hand-held devices, wireless devices, portable devices, wearable computer devices, cellular or mobile phone, portable digital assistants (PDAs),tablets, smart phones, smart watches, and the like. Although mobile devices 141-143 are described, in one or more embodiments, device 141-143 may be any computer device, such as, work stations, computers, general purpose computers, Internet appliances, ultrabooks, netbooks, laptops, desktops, multi-processor systems, microprocessor-based or programmable consumer electronics, network PCs, mini-computers, and the like. Although only three mobile devices are illustrated, it should be understood that fewer than three or more than three mobile devices can participate in a multi-display collaboration environment. In some embodiments, a user downloads an application on his mobile device to access the functionalities described herein, and to participate in the multi-display collaboration environment.

In some embodiments, a user can choose the topic or event for the statistical analysis model visualization. The user can also choose which digital display is configured to display which information. The user may be presented with visualization options and data options to choose from, as described above.

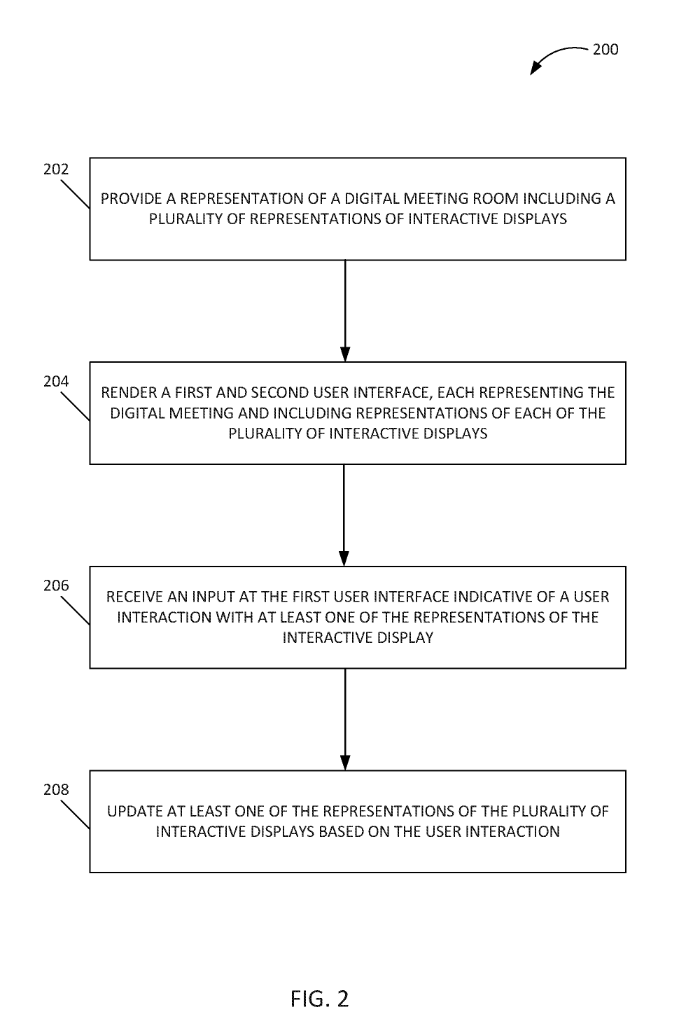

FIG. 2 is a flowchart illustrating an exemplary method 200 for configuring a graphical user interface in a remote collaboration environment, according to an example embodiment. The method 200 may be performed using or one or more components of system 100 described above.

At block 202, a representation of a digital meeting room is programmatically provided. The representation of the digital meeting room includes a plurality of representations of interactive displays, where each interactive display is configured to render a graphical representation of analyzed data. The representation of the digital room may be provided on a server, and represents digital room 130. The interactive displays are digital displays 131-134, and they are configured to display analyzed data provided by processors 121-124.

At block 204, a user interface is rendered on a mobile device. The user interface represents the digital meeting room and includes representations of each of the plurality of interactive displays. A user interface is rendered on each of mobile devices 141-143 participating in the multi-display collaboration environment. The plurality of interactive displays are configured to render a graphical representation of analyzed data. Thus, the user interface presents a plurality of displays with graphical representations of analyzed data to a user. The user can view the analyzed data and interact with the graphical representation of it.

In some embodiments, the user interface also includes a live video stream from each of mobile devices 141-143. In this manner, a user participating in a meeting or collaboration session via the multi-display collaboration environment is able to view the other users in the meeting. The live video stream may be provided by a camera or image capturing device provided on or coupled to mobile device 141, 142, 143. In some embodiments, the user interface may include an image of each of the users associated with mobile devices 141-143. In some embodiments, a user can turn-off his video, and disable his video stream from being presented in the user interface.

In example embodiments, the user interface also includes a list of users participating in the meeting or collaboration session. In alternative embodiments, the user interface includes a list of possible users to invite to participate in a meeting session. The list of possible users may be governed by security rules and clearance levels associated with a user. For example, a user may not be cleared to access the data and information that will be presented in a meeting, in which case, that user does not appear on the list of possible users to invite.

At block 206, an input is received at the user interface indicating a user interaction with at least one of the representations of the interactive displays in the user interface. The user interaction causes a modification of at least one of the rendered graphical representations of analyzed data on the at least one interactive display. The input can be received via the mobile device 141, 142, or 143 participating in the meeting. The user can enter the input via a touch-screen interface on the mobile device 141, 142, and 143. In alternative embodiments, the user can enter the input via a pointing device (for example, a mouse) or a keyboard in communication with the mobile device 141, 142, and 143. The user can interact and manipulate the graphical representation of the analyzed data displayed in a representation of the digital display 131, 132, 133, or 134 in the user interface rendered his mobile device 141, 142, or 143. For example, the user can zoom-in on a data point on a map, or drill down to a value on a chart.

The input indicating user interaction with the analyzed data is communicated from the mobile device 141, 142, 143 to the appropriate digital display 131, 132, 133, 134. That is, if the user input indicates interaction with data in the representation of digital display 132, then the input is communicated to digital display 132. The digital display 132 is updated to reflect the user input interacting with the graphical representation of the analyzed data.

At block 208, at least one of the representations of the plurality of interactive displays is updated based on the user interaction. As described above, the digital display 131, 132, 133 or 134 corresponding to the representation of the display in the user interface on the mobile device 141, 142, or 143 is updated to reflect the user interaction with the analyzed data. The updated digital display 131, 132, 133, or 134 then communicates the user interaction to the corresponding representations of the digital display on the mobile devices 141, 142, 143. For example, a user may interact with the representation of digital display 132 on his mobile device 141. The interaction is communicated to digital display 132, and digital display 132 is updated based on the interaction. The digital display 132 communicates the interaction to mobile devices 142 and 143, causing an update to the representation of the digital display 132 in the user interface rendered on the mobile device 142 and 143. In this manner, a user input indicating an interaction with a display in the user interface on his mobile device, is reflected in the user interfaces on the mobile devices of the other users. That is, if a user zooms-in to a data point, the zoom-in interaction is displayed to the other users. This feature facilitates collaboration during the meeting because a user can interact with data to gain more information, and share this information with other users.

In some embodiments, only the leader user is able to interact with the graphical representation of analyzed data in a user interface. In other embodiments, any user participating in the collaboration session can interact with the analyzed data. In some embodiments, a user may have an option to turn-off the feature that causes update to other user's mobile device. In this way, the user can interact with the analyzed data just for his benefit. In some embodiments, the interaction with the analyzed data is reflected on the touch-displays in the physical meeting room, so that users attending the meeting from the physical meeting room can also view the interactions with the analyzed data.

A user is able to select a display from the plurality of displays to bring into focus. That is, the user can select a display as his main display, so that that display is presented in the user interface on his mobile device in a larger size than the other displays. In some embodiments, if the user is the leader, the user interfaces on the other mobile devices participating in the meeting are also updated to reflect a larger representation of the display selected by the leader-user.

In some embodiments, one of the multiple interactive displays is a smart board, where users can write notes and comments. A user may be able to save the smart board as a screen shot, and share it with other users, for example, via e-mail. Many mobile devices provide the ability to control the device using hand gestures, such as, waving your hand in front of the device, pinching the screen to zoom-in, using multiple fingers to scroll, and the like. In some embodiments, a user may be able to use hand gestures to interact with the multiple displays in the user interface.

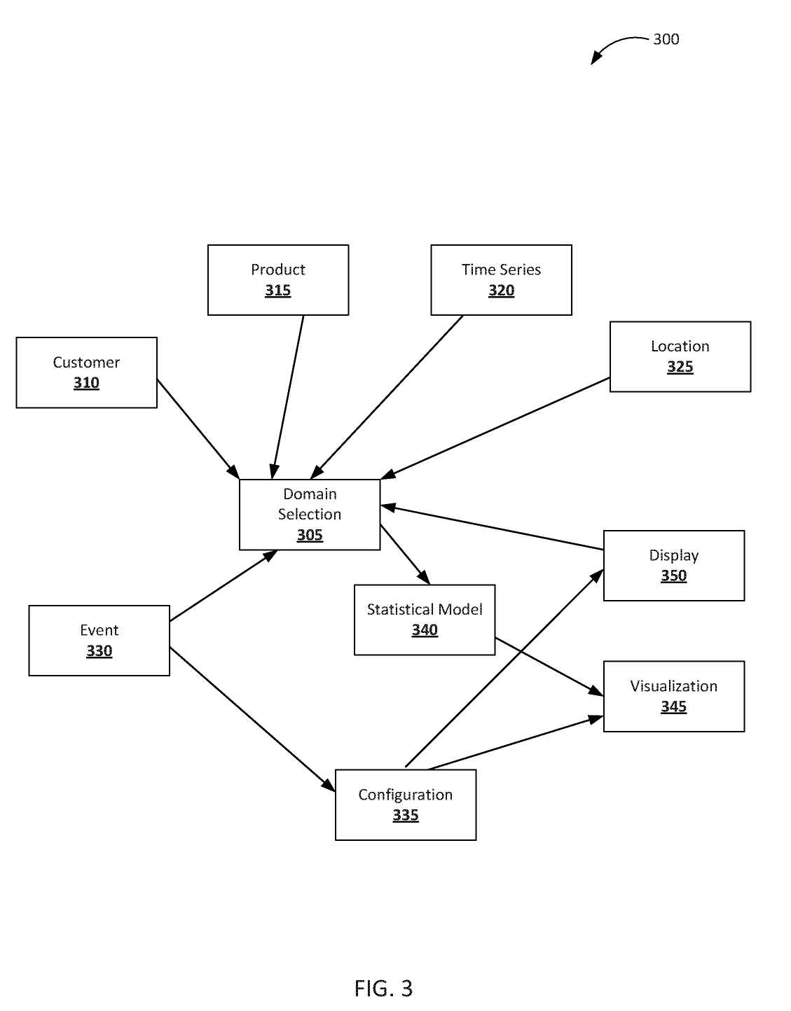

FIG. 3 is diagram illustrating an example system 300 in a multi-display collaboration environment, according to example embodiments. The example system 300 is illustrated in terms of a dataflow between various modules, such as, domain selection module 305, customer module 310, product module 315, time series module 320, location module 325, event module 330, configuration module 335, statistical model module 340, visualization module 345, and display module 350. These modules may be implemented or stored in any of the components of system 100, or may be in communication with any of the components of system 100. The domain selection module 305 can be used for determining the criteria for an event that is detected by the event module 330. Based on the criteria, the domain selection module 305 selects the topics or categories of data useful for analyzing an event. These topics or categories of data is provided by the customer module 310 (data related to customer information), the product module 315 (data related to product information), time series module 320 (data related to temporal information), and location module 325 (data related to geographic location). More or fewer such modules may be included in the multi-display collaboration environment to provide more or fewer categories of data. The configuration module 335 can be used for configuring the multiple digital displays based on the event detected by the event module 330. For example, the configuration module 335 determines which digital display displays a particular visualization of the data.

The statistical model module 340 can be used for generating a statistical analysis model for one or more categories of data selected by the domain selection module 305. A statistical analysis model may be generated using any appropriate statistical analysis techniques, such as, but not limited to, Bayesian networks, machine learning intelligence, a neural network, or any other statistical analysis tool in the art. The visualization module 345 can be used for generating a graphical representation or visualization of the statistical analysis model generated by the statistical model module 340. A graphical representation of the statistical analysis model may be, but not limited to, charts, graphs, maps, video, and the like. The display module 350 can be used for displaying the graphical representations generated by the visualization module 345 on digital displays, for example, the digital displays 131-134 described above. The digital display module 350 also can be used for receiving an input indicating user interaction with the visualizations displayed in the digital display via a mobile device, for example. The digital display module 350 communicates the user interaction to the domain selection module 305, which causes a modification of the visualizations displayed on the digital display, as described above. In a given implementation of example system 300, the display 350 can be a display of a smartphone, tablet, slate, e-reader, or other mobile device, used by a user in transit, and the display 350 can be a physical monitor for a user located in a physical meeting room. In this manner, the flow of data is facilitated between various modules that enable a multi-display collaboration environment.

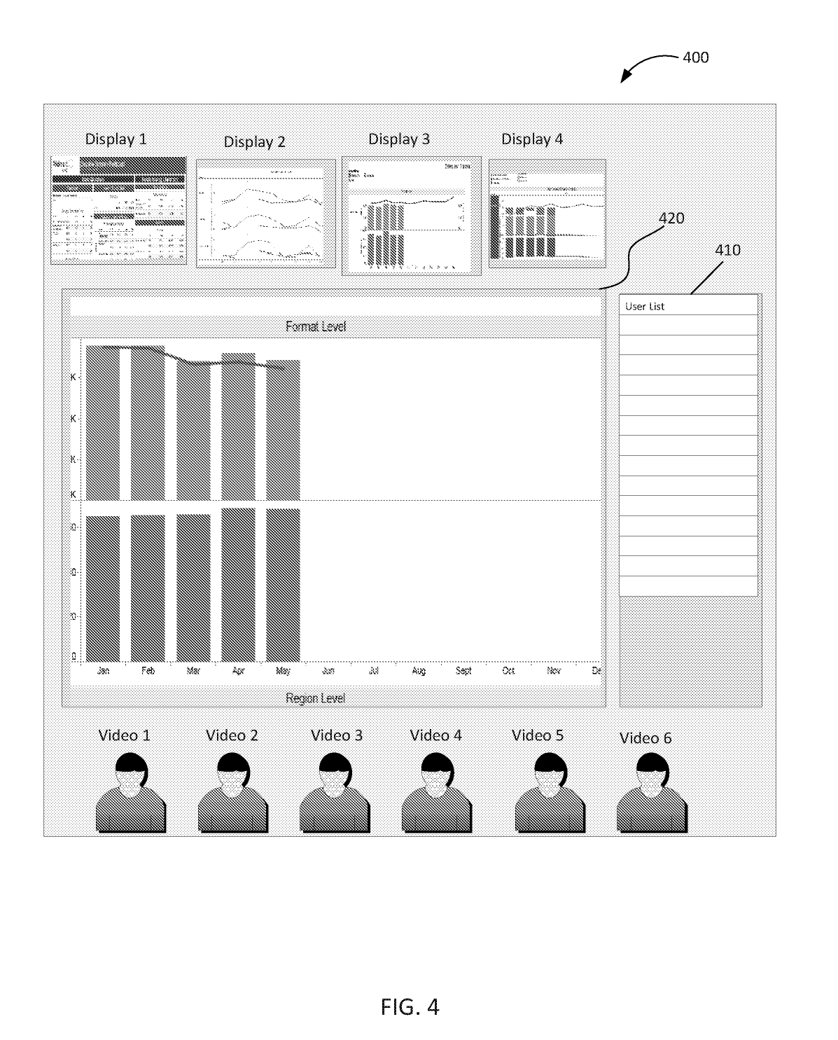

FIG. 4 is an exemplary graphical user interface screen 400 rendered on a mobile device in a multi-display collaboration environment, according to an embodiment. As shown in FIG. 4, user interface screen 400 includes five interactive displays displaying graphical representations of data. The user interface screen 400 also includes live video stream (shown as Video 1, Video 2, Video 3, Video 4, Video 5, and Video 6) from the mobile devices 141-143 participating in the multi-display collaboration environment. As described above, a user is able to view other users participating in the meeting. In alternative embodiments, images of the users are included instead of a video stream. The user interface screen 400 also includes a user list (shown as element 410) showing the names of the users participating in this particular instance of the multi-display collaboration environment. As described above, the user list 410 may include the list of possible users/attendees for a meeting. As shown, the user interface includes a larger representation (shown as element 420) of one of the interactive displays and smaller representations (shown as Display 1, Display 2, Display 3, and Display 4) of the other interactive displays.

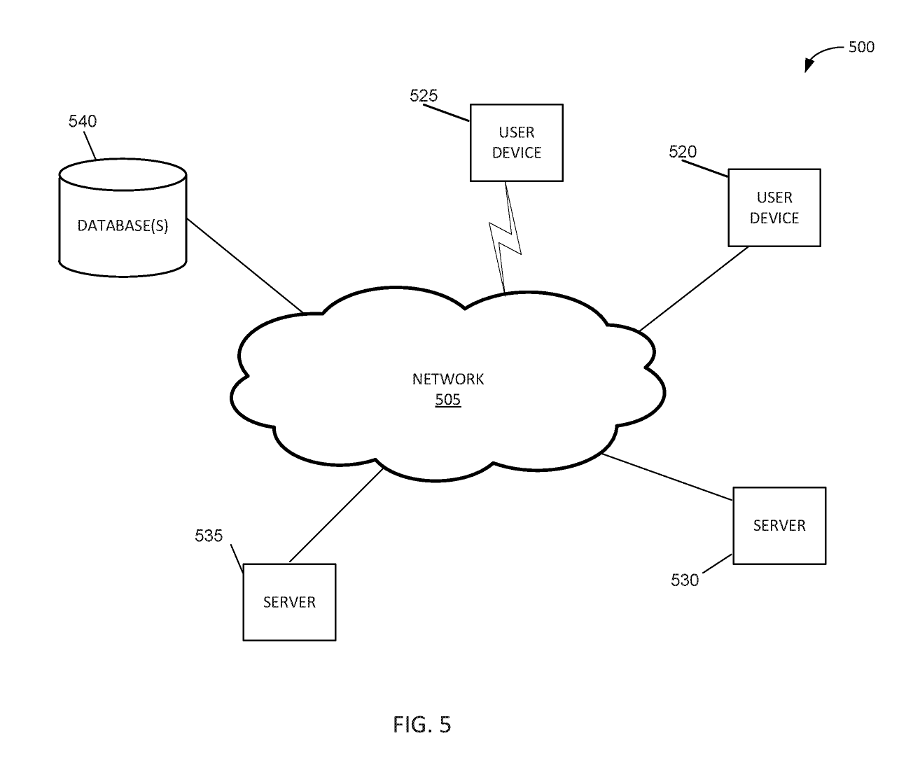

FIG. 5 is a diagram of an exemplary network environment suitable for a distributed implementation of exemplary embodiments of a multi-display collaboration environment. The system 500 can include a network 505, multiple user devices, for example, user device 520, user device 525, multiple servers, for example, server 530, server 535, and a database 540. Each of the user devices 520, 525, servers 530, 535, and databases 540 is in communication with the network 505.

One or more components of system 100 may be implemented in one or more user devices 520, 525. In other embodiments, one or more of components of system 100 may be included in one or more servers 530, 535 while other of the components of system 100 are provided in user devices 520, 525. The components of system 100 may include various circuits, circuitry and one or more software components, programs, applications, apps or other units of software code base or instructions configured to be executed by one or more processors included in user devices 520, 525 or server 530, 535.

In an example embodiment, one or more portions of network 505 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The user devices 520, 525 may comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. Each of user devices 520, 525 may connect to network 505 via a wired or wireless connection. Each of user devices 520, 525, may include one or more applications such as, but not limited to, a multi-display collaboration application, a remote collaboration application, a video streaming application, and the like. In an example embodiment, the user devices 520, 525 may perform all the functionalities described herein.

In other embodiments, the multi-display collaboration environment may be included on the servers 530, 535, and the servers 530, 535 perform the functionalities described herein. In yet another embodiment, the user devices 520, 525 may perform some of the functionalities, and servers 530, 535 perform the other functionalities described herein. For example, user devices 520, 525 may render a user interface with interactive displays and receive input interacting with the interactive displays, while servers 530, 535 may provide representations of digital meeting room and update the representations of the interactive displays based on the input received at the user devices 520, 525.

Each of the databases 540, and servers 530, 535 is connected to the network 505 via a wired connection. Alternatively, one or more of the databases 540, and servers 530, 535 may be connected to the network 505 via a wireless connection. Server 530, 535 comprise one or more computers or processors configured to communicate with user devices 520, 525 via network 505. Server 530, 535 hosts one or more applications or websites accessed by user devices 520, 525 and/or facilitates access to the content of databases 540. Databases 540 comprise one or more storage devices for storing data and/or instructions (or code) for use by server 530, 535, and/or user devices 520, 525. Databases 540 and server 530, 535 may be located at one or more geographically distributed locations from each other or from user devices 520, 525. Alternatively, databases 540 may be included within server 530, 535.

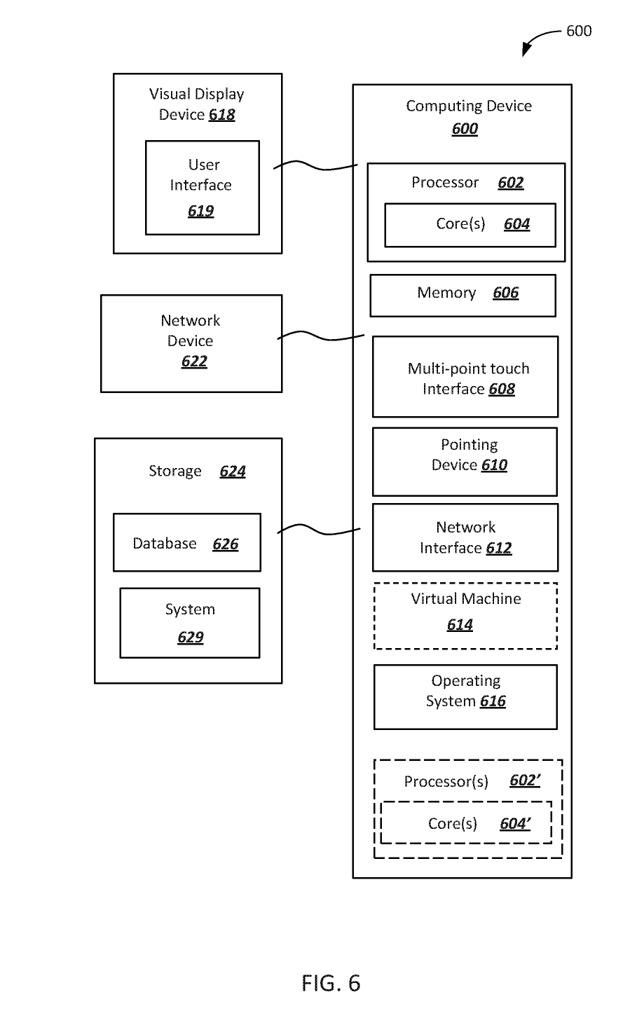

FIG. 6 is a block diagram of an exemplary computing device 600 that can be used to perform any of the methods provided by exemplary embodiments. The computing device 600 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 606 included in the computing device 600 can store computer-readable and computer-executable instructions or software for implementing exemplary embodiments. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor. Processor 602 and processor(s) 602′ may be any of the processors 121-124 described above, and may be configured to the perform the functionalities described with respect to any one or more of processors 121-124.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can include a computer system memory or random access memory, such as DRAM, SRAM, EDO RAM, and the like. Memory 606 can include other types of memory as well, or combinations thereof.

A user can interact with the computing device 600 through a visual display device 618, such as a touch screen display or computer monitor, which can display one or more user interfaces 619 that can be provided in accordance with exemplary embodiments, for example, the exemplary interfaces illustrated in FIG. 4. The visual display device 618 may be any one or more of the touch display devices 151-154 or a display device of any of the mobile devices 141-143. The visual display device 618 can also display other aspects, elements and/or information or data associated with exemplary embodiments, for example, views of databases, source code, and the like. The computing device 600 can include other I/O devices for receiving input from a user, for example, a keyboard or any suitable multi-point touch interface 608, a pointing device 610 (e.g., a pen, stylus, mouse, or trackpad). The keyboard 608 and the pointing device 610 can be coupled to the visual display device 618. The computing device 600 can include other suitable conventional I/O peripherals.

The computing device 600 can also include one or more storage devices 624, such as a hard-drive, CD-ROM, or other computer readable media, for storing data and computer-readable instructions and/or software, such as the system 629 that implements exemplary embodiments of the multi-display collaboration environment as taught herein, or portions thereof, which can be executed to generate user interface 619 on display 618. For example, system 629 may be one or more components of system 100 shown in FIG. 1. As another example, system 629 may be one or more modules of system 300 shown in FIG. 3. Exemplary storage device 624 can also store one or more databases for storing any suitable information required to implement exemplary embodiments. The databases can be updated by a user or automatically at any suitable time to add, delete or update one or more items in the databases. Exemplary storage device 624 can store one or more databases 626 for storing customer information, sales information, product information, demand and distribution information, interaction information, user information, digital meeting room information, algorithms and statistical analysis information, analyzed data, statistical analysis model visualization information, and any other data/information used to implement exemplary embodiments of the systems and methods described herein.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. A method for configuring a graphical user interface in a remote collaboration environment, the method comprising:
programmatically providing a representation of a digital meeting room in a remote collaboration environment, the representation of the digital meeting room comprising representations of each of a plurality interactive displays, each of the representations of the plurality of interactive displays being configured to render a graphical representation of analyzed data;
rendering a first graphical user interface on a first mobile device and a second graphical user interface on a second mobile device, each of the first graphical user interface and the second graphical user interface representing the digital meeting room, and each of the first graphical user interface and the second graphical user interface comprising the representations of each of the plurality of interactive displays;
receiving an input at the first graphical user interface of the first mobile device, the input being indicative of a user interaction with at least one of the representations of the plurality of interactive displays, wherein the user interaction causes a modification of at least one of the rendered graphical representations of the analyzed data of a first interactive display of the plurality of interactive displays to provide at least one modified graphical representation; and
updating at least one of the representations of the plurality of interactive displays of the second graphical user interface rendered on the second mobile device to display the at least one modified graphical representations.

2. The method of claim 1, wherein each of the plurality of interactive displays is configured to render a statistical analysis model of a data set to provide the analyzed data.

3. The method of claim 2, wherein the statistical analysis model of each of the interactive displays is computed using a separate computing device.

4. The method of claim 2, wherein the statistical analysis model of at least one of the plurality of interactive displays is computed based on data collected in real-time.

5. The method of claim 2, wherein the statistical analysis model rendered on a first interactive display of the plurality of interactive displays corresponds to a larger data set than the statistical analysis model rendered on a second interactive display of the plurality of interactive displays.

6. The method of claim 2, further comprising automatically updating a statistical analysis model of a representation of a second interactive display of the plurality of interactive displays at the first graphical user interface of the first mobile device in response to the user interaction.

7. The method of claim 2, wherein at least one of the plurality of interactive displays comprises a plurality of interactive task representations, and wherein at least one of the plurality of interactive task representations corresponds to the statistical analysis model of one of the plurality of interactive displays.

8. The method of claim 7, wherein the plurality of representations of the plurality of interactive displays are separately selectable based on a user interaction with at least one of the plurality of interactive task representations.

9. The method of claim 1, wherein each of the first graphical user interface and the second graphical user interface further comprises a live video stream from a plurality of mobile devices participating in the digital meeting room.

10. The method of claim 1, wherein each of the first graphical user interface and the second graphical user interface includes a larger representation of one of the plurality of interactive displays and smaller representations of the other interactive displays of the plurality of interactive displays.

11. A system for configuring a graphical user interface in a remote collaboration environment, the system comprising:
a first server configured to provide a digital meeting room in a remote collaboration environment, the digital meeting room comprising a plurality of interactive displays, each of the plurality of interactive displays being configured to render a graphical representation of analyzed data; and
a second server in communication with the first server and configured to render a first graphical user interface on a first mobile device and a second graphical user interface on a second mobile device, each of the first graphical user interface and the second graphical user interface representing the digital meeting room, and each of the first graphical user interface and the second graphical user interface comprising representations of each of the plurality of interactive displays;
wherein:
the second server is further configured to receive an input at the first graphical user interface of the first mobile device, the input being indicative of a user interaction with at least one of the representations of the plurality of interactive displays, the user interaction causing a modification of at least one of the rendered graphical representations of the analyzed data of a first interactive display of the plurality of interactive displays to provide at least one modified graphical representation; and
the first server is further configured to update at least one of the representation of the plurality of interactive displays of the second graphical user interface rendered on the second mobile device to display the at least one modified graphical representations.

12. The system of claim 11, wherein each of the plurality of interactive displays is configured to render a statistical analysis model of a data set to provide the analyzed data.

13. The system of claim 12, wherein the statistical analysis model of each of the plurality of interactive displays is computed using a separate computing device.

14. The system of claim 12, wherein the statistical analysis model of at least one of the plurality of interactive displays is computed based on data collected in real-time.

15. The system of claim 12, wherein the statistical analysis model rendered on a first interactive display of the plurality of interactive displays corresponds to a larger data set than the statistical analysis model rendered on a second interactive display of the plurality of interactive displays.

16. The system of claim 12, wherein the first server is configured to automatically update a statistical analysis model of a representation of a second interactive display of the plurality of interactive displays at the first graphical user interface of the first mobile device in response to the user interaction.

17. The system of claim 12, wherein at least one of the plurality of interactive displays comprises a plurality of interactive task representations, and wherein at least one of the plurality of interactive task representations corresponds to the statistical analysis model of one of the plurality of interactive displays.

18. A non-transitory machine readable medium storing instructions executable by a processing device, wherein execution of the instructions causes the processing device to implement a method for configuring a graphical user interface in a remote collaboration environment, the method comprising:
programmatically providing a representation of a digital meeting room in a remote collaboration environment, the representation of the digital meeting room comprising representations of each of a plurality of interactive displays, each of the representations of the plurality of interactive displays being configured to render a graphical representation of analyzed data;
rendering a first graphical user interface on a first mobile device and a second graphical user interface on a second mobile device, each of the first graphical user interface and the second graphical user interface representing the digital meeting room, each of the first graphical user interface and the second graphical user interface comprising the representations of each of the plurality of interactive displays;
receiving an input at the first graphical user interface of the first mobile device, the input being indicative of a user interaction with at least one of the representations of the plurality of interactive displays, wherein the user interaction causes a modification of at least one of the rendered graphical representations of the analyzed data of a first interactive display of the plurality of interactive displays to provide at least one modified graphical representation; and
updating at least one of the representations of the plurality of interactive displays of the second graphical user interface rendered on the second mobile device to display the at least one modified graphical representation.

19. The non-transitory machine readable medium of claim 18, wherein each of the plurality of interactive displays is configured to render a statistical analysis model of a data set to provide the analyzed data.

20. The non-transitory machine readable medium of claim 19, wherein the statistical analysis model rendered on a first interactive display of the plurality of interactive displays corresponds to a larger data set than the statistical analysis model rendered on a second interactive display of the plurality of interactive displays.
